(19) United States
(12) Patent Application Publication
(10) Pub. No.: US 2014/0084559 A1
(43) Pub. Date: Mar. 27, 2014

(54) WHEELED WALKER WITH DUAL-BRAKE SYSTEMS

(71) Applicant: HUI ZHOU ANDON INDUSTRIES CO., LTD., Hui Zhou City (TW)

(72) Inventor: Yu-Chu FANG, Taipei (TW)

(73) Assignee: HUI ZHOU ANDON INDUSTRIES CO., LTD., Hui Zhou City (CN)

(21) Appl. No.: 13/669,508

(22) Filed: Nov. 6, 2012

(30) Foreign Application Priority Data
Sep. 26, 2012 (CN) 201220493026.0

(51) Int. Cl. A61H 3/04

(52) U.S. Cl. CPC A61H 3/04
USPC 280/47.38

(57) ABSTRACT

A wheeled walker with dual-brake systems has a frame, two grips, at least three wheels, a seat cushion, at least one brake assembly, at least one manual system, and at least one seat actuating system. The brake assembly selectively stops the wheel. The seat actuating system is connected to the brake assembly and has a seat actuating segment and a seat brake cable. The seat actuating segment is mounted pivotally on the frame and selectively abuts the seat cushion. When a user sits on the seat cushion, the seat cushion presses downward the seat actuating segment. Then the seat actuating segment actuates the brake assembly to stop the corresponding wheel. Therefore, the brake assembly actuates the brake automatically when the user sits on the wheeled walker.

### BACKGROUND OF THE INVENTION

1. Field of the Invention

The present invention relates to a wheeled walker, especially to a wheeled walker with dual-brake systems that can actuate the brake automatically when a user sits on the wheeled walker.

2. Description of the Prior Arts

A wheeled walker has a frame with wheels and can be pushed to move. When a user has difficulty walking steadily, the user pushes the wheeled walker when walking to keep the balance.

The conventional wheeled walker has a frame, two grips, four wheels, a seat cushion, a seat back, a brake assembly and a manual system. The grips are separately mounted on a top of the frame, and are toward the same direction. The wheels are mounted rotatably on a bottom of the frame and are arranged in a rectangle. The seat cushion is mounted on the frame and is mounted between the grips and the wheels. The seat back is mounted on the frame and is mounted above a side of the seat cushion. The brake assembly is mounted on the frame and is mounted next to one of the wheels. The manual system is mounted on the frame and has an actuating segment and a brake cable. The actuating segment is mounted on one of the grips. The brake cable connects the actuating segment and the brake assembly.

When the user wants to actuate the brake assembly, the user presses the actuating segment on the grip. Then the brake cable pulls the brake assembly next to one of the wheels to stop the wheel. Besides, the user can sit on the seat cushion and lean on the seat back to take a break when feeling tired.

However, the brake assembly only can be actuated by the manual system and cannot be actuated automatically. Therefore, if the user sits on the seat cushion and forgets to press the manual system, the wheeled walker is slidable, which is dangerous to the user sitting on the wheeled walker.

To overcome the shortcomings, the present invention provides a wheeled walker with dual-brake systems to mitigate or obviate the aforementioned problems.

### SUMMARY OF THE INVENTION

The main objective of the present invention is to provide a wheeled walker with dual-brake systems that can actuate the brake automatically when a user sits on the wheeled walker.

The wheeled walker with dual-brake systems in accordance with the present invention has a frame, two grips, at least three wheels, a seat cushion, at least one brake assembly, at least one manual system, and at least one seat actuating system. The grips are mounted on a top of the frame. The wheels are mounted rotatably on a bottom of the frame. The seat cushion is mounted pivotally on the frame and mounted between the grips and the wheels. The brake assembly is mounted on the frame, is mounted next to a corresponding wheel and selectively stops the wheel. The manual system is mounted on the frame, is connected to the brake assembly and actuates the brake assembly. The seat actuating system is mounted on the frame, is connected to the brake assembly and has a seat actuating segment and a seat brake cable. The seat actuating segment is mounted pivotally on the frame and selectively abuts the seat cushion. The seat brake cable is connected to the seat actuating segment and the brake assembly.

When a user sits on the seat cushion, the seat cushion presses downward the seat actuating segment of the seat actuating system. Then the seat actuating segment pulls the seat brake cable, and the seat brake cable pulls and actuates the brake assembly to stop the corresponding wheel. Therefore, the brake assembly actuates the brake automatically when the user sits on the wheeled walker. The user does not have to worry about forgetting to actuate the brake when sitting on the wheeled walker.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a wheeled walker with dual-brake systems in accordance with the present invention;

FIG. 2 is a side view of the wheeled walker with dual-brake systems in FIG. 1;

FIG. 3 is an enlarged side view of the brake assembly of the wheeled walker with dual-brake systems in FIG. 1;

FIG. 4 is an enlarged front view of the seat actuating segment of the wheeled walker with dual-brake systems in FIG. 1;

FIG. 5 is an enlarged side view of the brake assembly of the wheeled walker with dual-brake systems in FIG. 1, showing the brake actuated;

FIG. 6 is a side view of the wheeled walker with dual-brake systems in FIG. 1, showing the seat cushion pressed downward;

FIG. 7 is an enlarged front view of the seat actuating segment of the wheeled walker with dual-brake systems in FIG. 1, showing the brake actuated; and

FIG. 8 is a side view of the wheeled walker with dual-brake systems in FIG. 1, showing the frame folded.

### DETAILED DESCRIPTION OF THE PREFERRED EMBODIMENTS

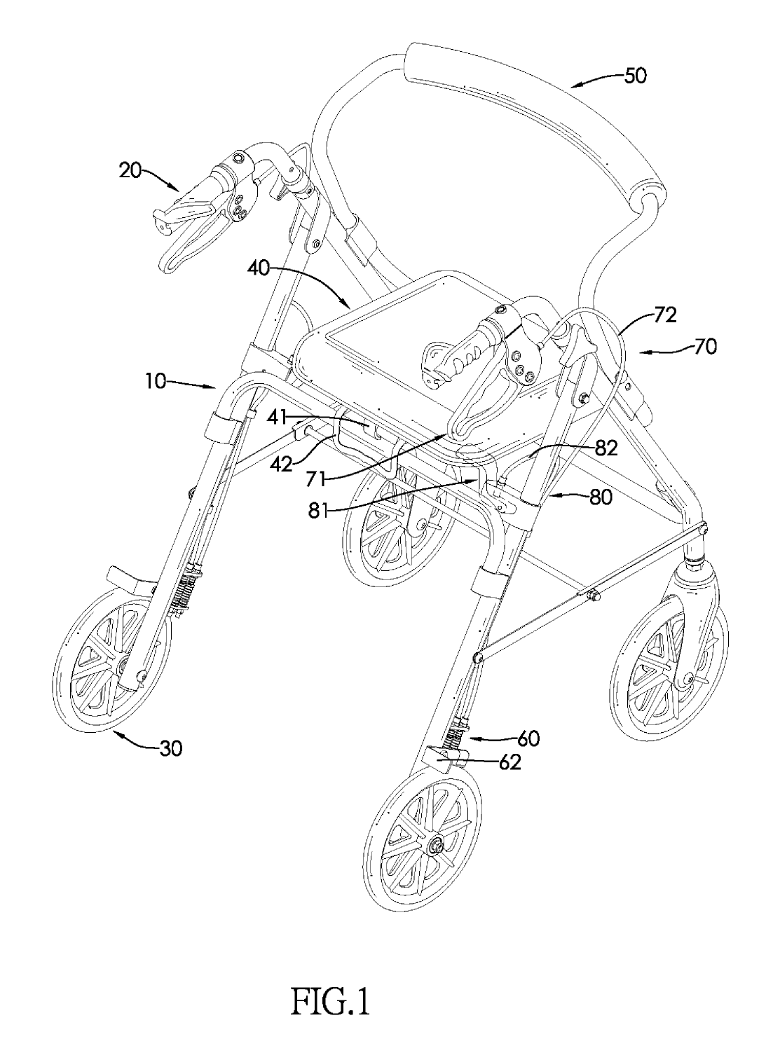

With reference to FIG. 1, a wheeled walker with dual-brake systems in accordance with the present invention comprises a frame 10, two grips 20, at least three wheels 30, a seat cushion 40, at least one brake assembly 60, at least one manual system 70 and at least one seat actuating system 80. In a preferred embodiment, the wheeled walker with dual-brake systems further comprises a seat back 50.

In a preferred embodiment, the frame 10 is foldable and has at least two frame segments mounted pivotally to each other.

The grips 20 are mounted separately on a top of the frame 10. In a preferred embodiment, the grips 20 protrude backward.

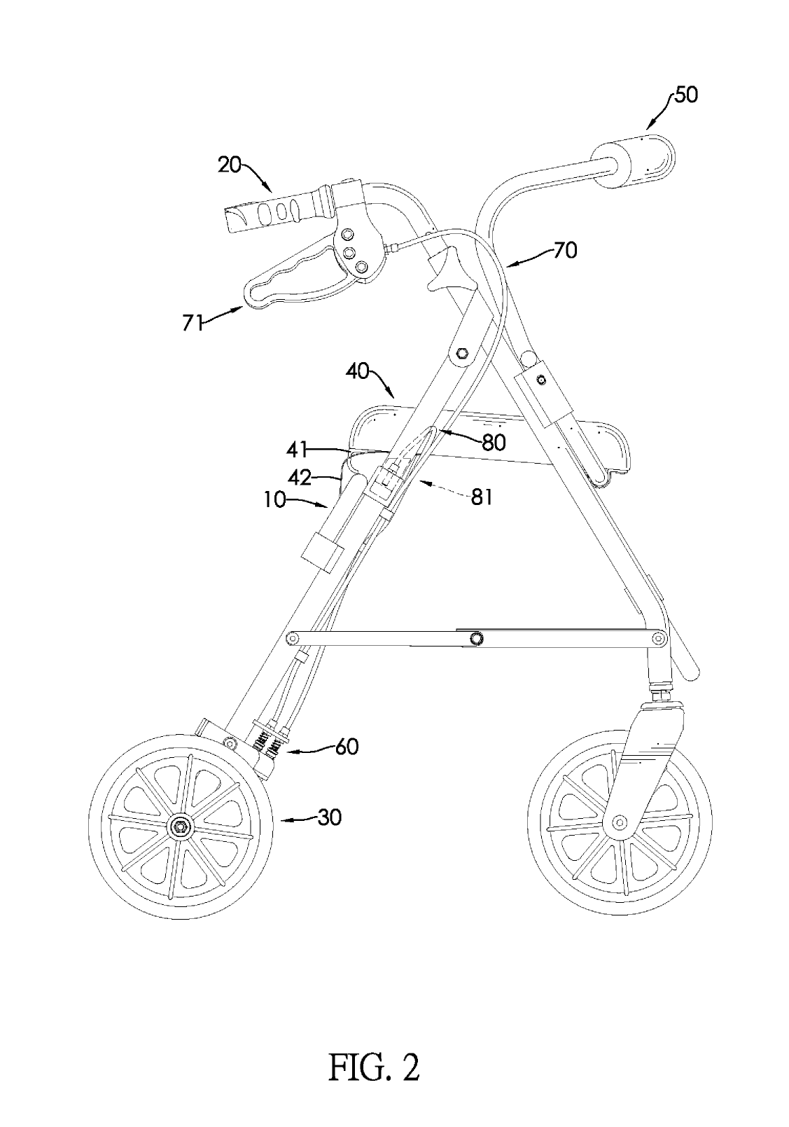

With reference to FIGS. 1 and 2, the wheels 30 are mounted rotatably on a bottom of the frame 10. In a preferred embodiment, the wheeled walker in accordance with the present invention has four wheels 30. The four wheels 30 are arranged in a rectangle and two of the wheels 30 are front wheels 30 and the other two of the wheels 30 are rear wheels 30. Two pivoting seats are respectively mounted on the front wheels 30 and are mounted pivotally to the frame 10 so that the front wheels 30 can turn left or right relative to the frame 10.

The seat cushion 40 is mounted pivotally on the frame 10 and is mounted between the grips 20 and the wheels 30. In a preferred embodiment, a front side of the seat cushion 40 is mounted pivotally to the frame 10. The seat cushion 40 further has a connector 41 and a puller 42 mounted on a back side of the seat cushion 40. The connector 41 is detachably connected to the frame 10. Preferably, the connector 41 is a hook. Two ends of the puller 42 are connected to the seat cushion 40.

The seat back 50 is mounted on the frame 10 and is mounted above a side of the seat cushion 40. In a preferred embodiment, the seat back 50 is a curved rod and is mounted in front of the seat cushion 40.

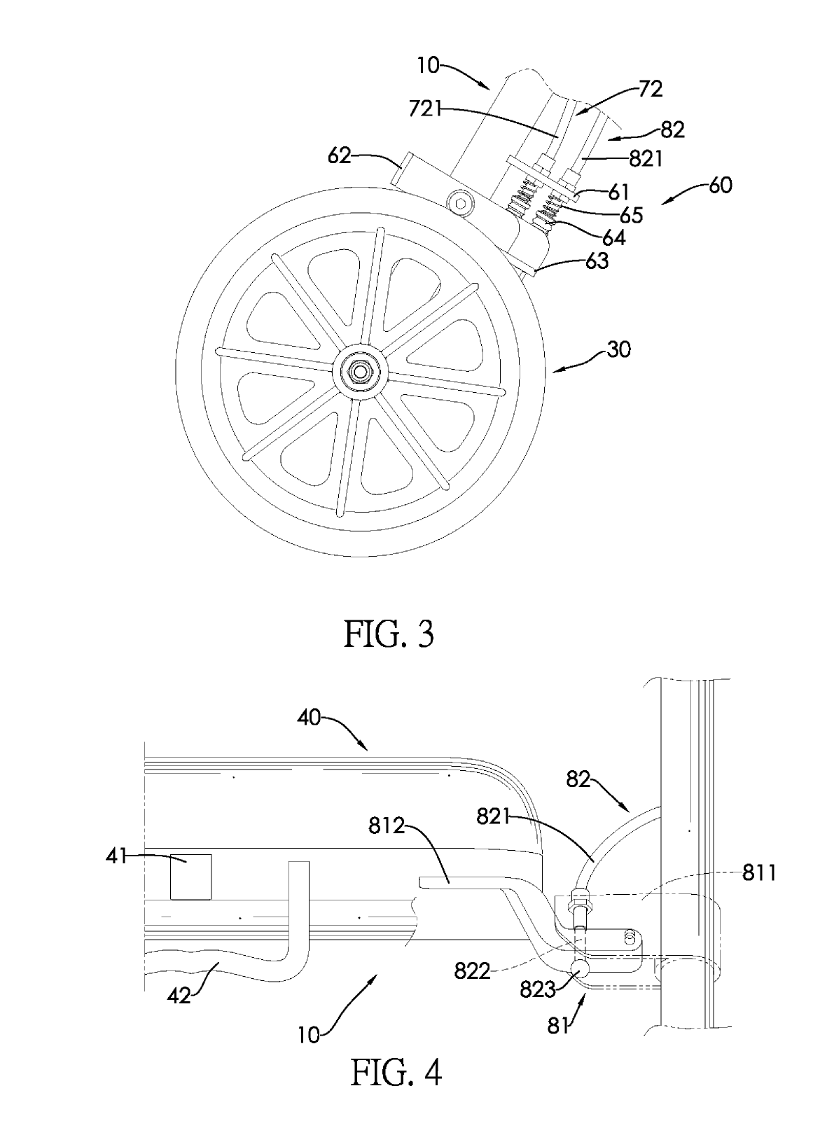

With reference to FIGS. 1 to 3, the at least one brake assembly 60 is mounted on the frame 10, is mounted next to a corresponding wheel 30 and selectively stops the corresponding wheel 30. In a preferred embodiment, the wheeled walker in accordance with the present invention has two brake assemblies 60. The brake assemblies 60 are respectively mounted above the back wheels 30. Each brake assembly 60 has a top panel 61, a brake element 62, a bottom panel 63, two resilient elements 65 and two sheathes 64. A side of the top panel 61 is mounted on the frame 10 and is mounted above the corresponding wheel 30. The brake element 62 is mounted pivotally to the frame 10, is mounted above the corresponding wheel 30 and selectively abuts the corresponding wheel 30. The bottom panel 63 is formed integratedly on the brake element 62 and is mounted below the top panel 61. The resilient elements 65 are mounted between the top panel 61 and the bottom panel 63 and push the bottom panel 63 downward. Preferably, the resilient elements 65 are springs. The sheaths 64 are respectively mounted around the resilient elements 65.

The at least one manual system 70 is mounted on the frame 10, is connected to a corresponding brake assembly 60 and actuates the corresponding brake assembly 60. In a preferred embodiment, the wheeled walker in accordance with the present invention has two manual systems 70. The manual systems 70 are respectively connected to the two brake assemblies 60. Each manual system 70 has a manual actuating segment 71 and a manual brake cable 72. The manual actuating segment 71 is mounted on a corresponding grip 20. The manual brake cable 72 is connected to the manual actuating segment 71 and the corresponding brake assembly 60, and includes a tube 721 and a cable body. The tube 721 is connected to the manual actuating segment 71 and the top panel 61 of the corresponding brake assembly 60. The cable body is mounted through the tube 721 and is connected to the manual actuating segment 71 and the bottom panel 63 of the corresponding brake assembly 60.

With reference to FIGS. 1 to 4, the at least one seat actuating system 80 is mounted on the frame 10, is connected to a corresponding brake assembly 60 and each one of the at least one seat actuating system 80 has a seat actuating segment 81 and a seat brake cable 82. The seat actuating segment 81 is mounted pivotally on the frame 10 and selectively abuts the seat cushion 40. The seat brake cable 82 is connected to the seat actuating segment 81 and the corresponding brake assembly 60. In a preferred embodiment, the wheeled walker in accordance with the present invention has two seat actuating systems 80. The seat actuating systems 80 are respectively connected to the two brake assemblies 60. Each seat actuating segment 81 has a stationary element 811 and a rotator 812. The stationary element 811 is mounted on the frame 10. The rotator 812 is mounted pivotally to the stationary element 811. The seat brake cable 82 includes a tube 821 and a cable body 822. The tube 821 is connected to the stationary element 811 of the seat actuating segment 81 and the top panel 61 of the corresponding brake assembly 60. The cable body 822 is mounted through the tube 821 and is connected to the rotator 812 of the seat actuating segment 81 and the bottom panel 63 of the corresponding brake assembly 60. The cable body 822 is mounted through the rotator 812. A bead 823 is mounted on a top end of the cable body 822 and abuts the rotator 812.

When a user wants to push the wheeled walker with dual-brake systems as described to assist walking, the connector 41 on the back side of the seat cushion 40 abuts the frame 10 but does not hook the frame 10. Therefore, the seat cushion 40 does not press the rotator 812 of the seat actuating system 80, and the brake assembly 60 is not actuated. Then the user can push the wheeled walker to move.

With reference to FIGS. 1, 2 and 5, if the user wants to actuate the brake just for a while, the user presses the manual actuating segment 71 on the grip 20. Then the cable body of the manual brake cable 72 pulls upward the bottom panel 63 with the brake element 62 of the brake assembly 60. The brake element 62 is rotated relative to the frame 10 and abuts the corresponding wheel 30 to stop the wheel 30 from rotating. Therefore, the brake is actuated. With reference to FIGS. 1 to 3, once the user stops pressing the manual actuating segment 71, the resilient elements 65 of the brake assembly 60 push downward the bottom panel 63. Then the brake element 62 is rotated to the original angle and does not abut the corresponding wheel 30, and the brake is released.

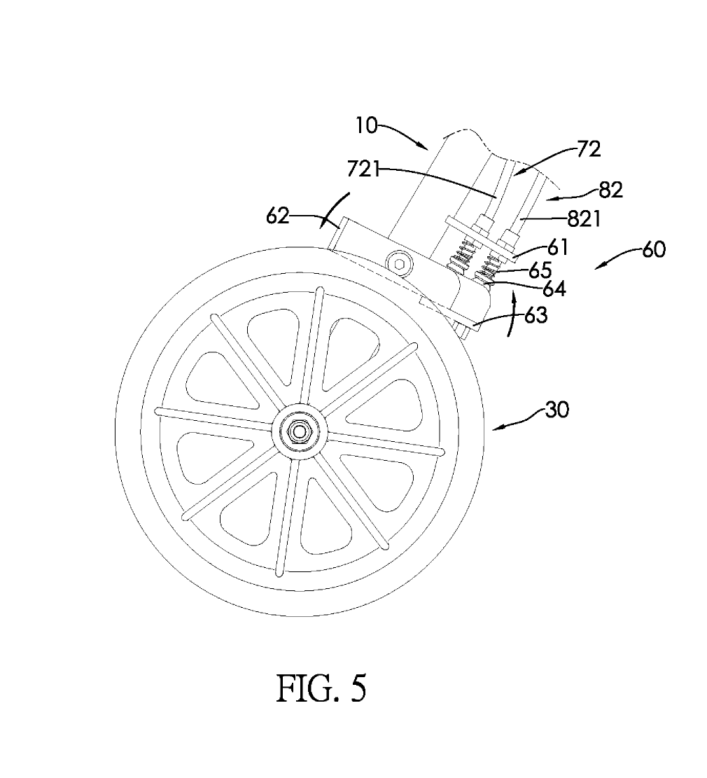

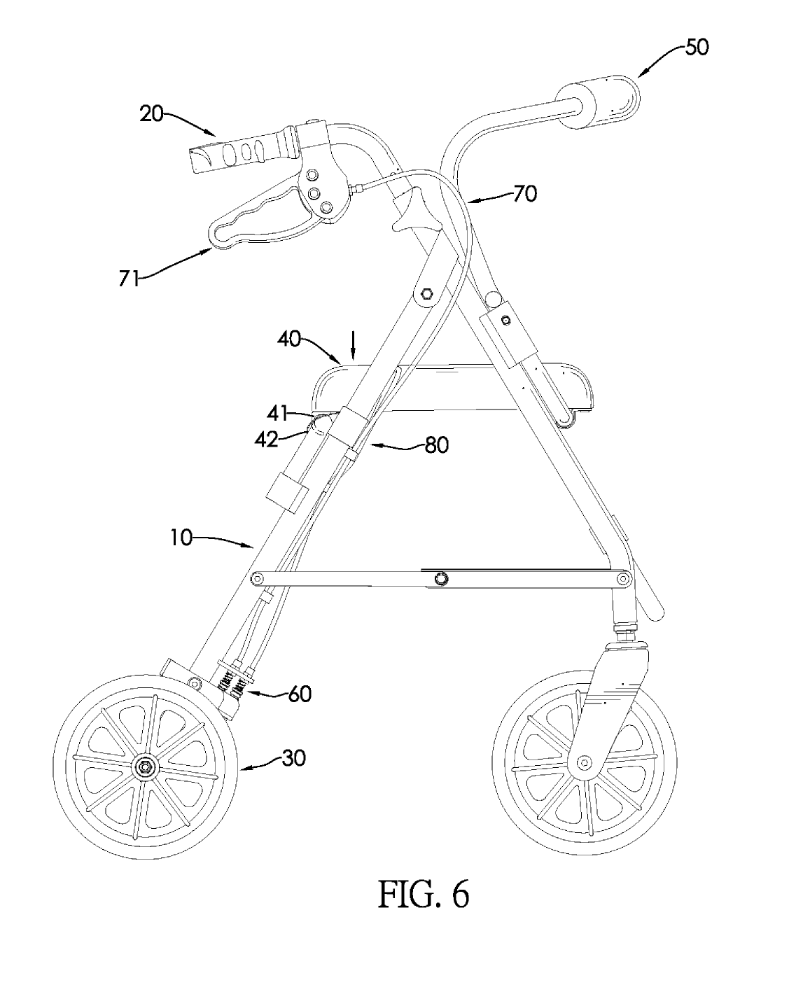

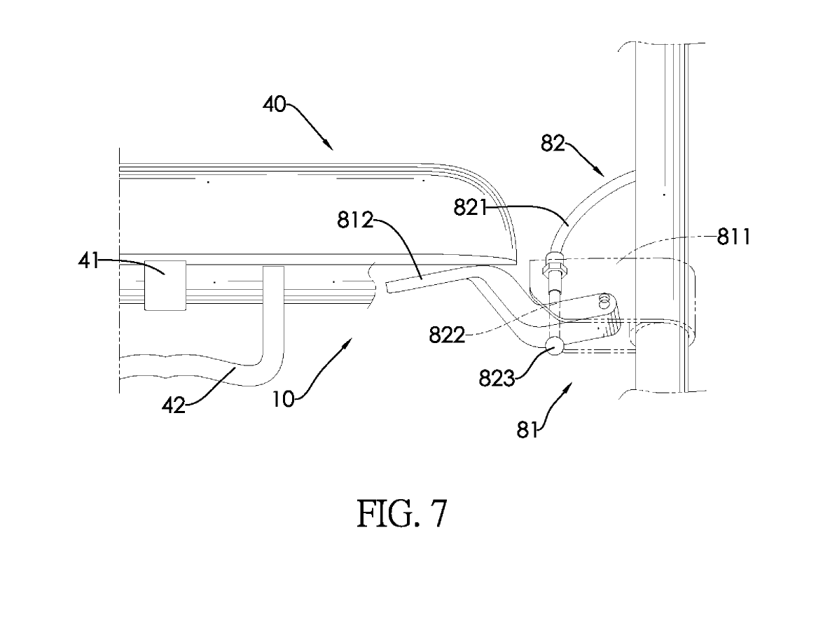

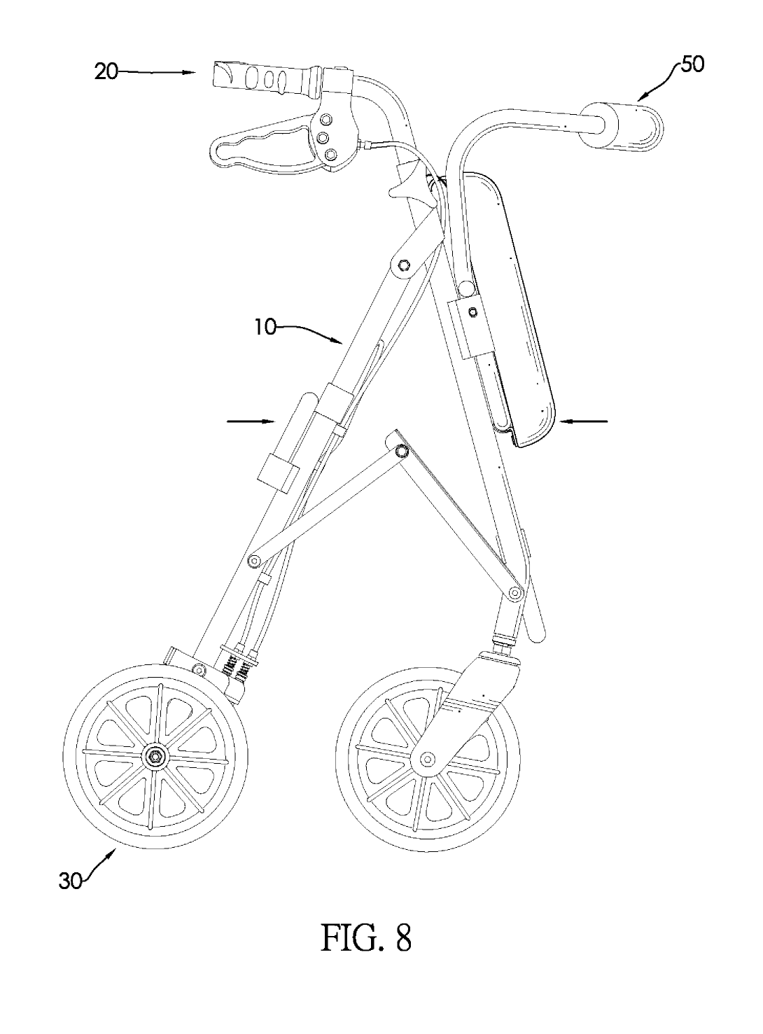

With reference to FIGS. 5 to 7, if the user wants to actuate the brake for a long time, the user pushes down the seat cushion 40 to further rotate the seat cushion 40 until the connector 41 hooks on the frame 10. A bottom of the seat cushion 40 presses the rotator 812 of the seat actuating segment 81, and the rotator 812 rotates and pulls the cable body 822 of the seat brake cable 82. In the same way, the cable body 822 pulls upward the top panel 63 of the brake assembly 60, and the brake element 62 rotates, abuts the corresponding wheel 30 and stops the wheel 30 from rotating. The seat actuating system 80 differs from the manual system 70 in that once the connector 41 of the seat cushion 40 hooks on the frame 10, the seat cushion 40 is held by the frame 10 and can keep pressing the rotator 812 even though the user stops pressing the seat cushion 40. Therefore, the brake assembly 60 can remain actuated. Then the user can free his both hands and does not have to worry about the wheeled walker may slide downward on a slope.

Besides, when the user feels tired after long time of walking and wants to sit on the seat cushion 40 to take a break, the seat cushion 40 is pressed by the user such that the connector 41 would definitely hook on the frame 10, which means the rotator 812 is pressed. Therefore, the brake assembly 60 is actuated automatically, and the user does not have to worry about forgetting to actuate the brake when sitting on the wheeled walker.

Moreover, when the user wants to release the brake, the user can pull up the puller 42 to lift up the seat cushion 40, or directly pull up the seat cushion 40. Afterwards, the connector 41 of the seat cushion 40 abuts the frame 10 but does not hook the frame 10. Therefore, the seat cushion 40 does not press the rotator 812 of the seat actuating system 80, and the brake assembly 60 is not actuated. Then the brake is released.

With reference to FIG. 8, finally, when the wheeled walker as described is not used, the frame 10 is foldable to save storage space.

In another preferred embodiment, the seat cushion can has no connector. Normally, the bottom of the seat cushion abuts the rotator of the seat actuating segment, but the seat cushion is not heavy enough to press down the rotator. Therefore the brake assembly is not actuated. When the user sits on the seat cushion, the user further rotates the seat cushion, and the seat cushion presses the rotator to actuate the brake assembly.

In another preferred embodiment, the manual system and the seat actuating system are not connected to the same brake assembly. The manual system and the seat actuating system are connected to different brake assemblies, which also can reach the same goal of actuating the brake automatically when a user sits on the wheeled walker.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A wheeled walker with dual-brake systems comprising:
a frame;
two grips mounted separately on a top of the frame;
at least three wheels mounted rotatably on a bottom of the frame;
a seat cushion mounted pivotally on the frame and mounted between the grips and the at least three wheels;
at least one brake assembly mounted on the frame, mounted next to a corresponding wheel and selectively stopping the corresponding wheel;
at least one manual system mounted on the frame, connected to a corresponding brake assembly and actuating the corresponding brake assembly; and
at least one seat actuating system mounted on the frame, connected to a corresponding brake assembly and each one of the at least one seat actuating system having
a seat actuating segment mounted pivotally on the frame and selectively abutting the seat cushion; and
a seat brake cable connected to the seat actuating segment and the corresponding brake assembly.

2. The wheeled walker with dual-brake systems as claimed in claim 1, wherein each one of the at least one manual system has
a manual actuating segment mounted on a corresponding grip; and
a manual brake cable connected to the manual actuating segment and the corresponding brake assembly.

3. The wheeled walker with dual-brake systems as claimed in claim 2, wherein each one of the at least one brake assembly connects to a corresponding manual system and a corresponding seat actuating system.

4. The wheeled walker with dual-brake systems as claimed in claim 3, wherein
each one of the at least one brake assembly has
a top panel mounted on the frame and mounted next to the corresponding wheel;
a brake element mounted pivotally to the frame and selectively abutting the corresponding wheel;
a bottom panel connected to the brake element and mounted below the top panel; and
two resilient elements mounted between the top panel and the bottom panel and pushing the bottom panel downward;
the manual brake cable of each one of the at least one manual system includes
a tube connected to the manual actuating segment and the top panel of the corresponding brake assembly; and
a cable body mounted through the tube of the manual brake cable and connected to the manual actuating segment and the bottom panel of the corresponding brake assembly; and
the seat brake cable of each one of the at least one seat actuating system includes
a tube connected to the seat actuating segment and the top panel of the corresponding brake assembly; and
a cable body mounted through the tube of the seat brake cable and connected to the seat actuating segment and the bottom panel of the corresponding brake assembly.

5. The wheeled walker with dual-brake systems as claimed in claim 4, wherein the seat actuating segment of each one of the at least one seat actuating system has
a stationary element mounted on the frame and connected securely to the tube of the seat brake cable; and
a rotator mounted pivotally to the stationary element and connected securely to the cable body of the seat brake cable.

6. The wheeled walker with dual-brake systems as claimed in claim 3, wherein
the number of the brake assembly is two;
the number of the manual system is two; and
the number of the seat actuating system is two.

7. The wheeled walker with dual-brake systems as claimed in claim 5, wherein
the number of the brake assembly is two;
the number of the manual system is two; and
the number of the seat actuating system is two.

8. The wheeled walker with dual-brake systems as claimed in claim 1, wherein the seat cushion further has a connector detachably connected to the frame.

9. The wheeled walker with dual-brake systems as claimed in claim 7, wherein the seat cushion further has a connector detachably connected to the frame.

10. The wheeled walker with dual-brake systems as claimed in claim 8, wherein the connector of the seat cushion is a hook.

11. The wheeled walker with dual-brake systems as claimed in claim 9, wherein the connector of the seat cushion is a hook.

12. The wheeled walker with dual-brake systems as claimed in claim 1, wherein the seat cushion further has a puller having two ends connected to the seat cushion.

13. The wheeled walker with dual-brake systems as claimed in claim 11, wherein the seat cushion further has a puller having two ends connected to the seat cushion.

14. The wheeled walker with dual-brake systems as claimed in claim 1, wherein the frame is foldable.

15. The wheeled walker with dual-brake systems as claimed in claim 13, wherein the frame is foldable.

16. The wheeled walker with dual-brake systems as claimed in claim 1, wherein the number of the wheels is four, and the four wheels are arranged in a rectangle.

17. The wheeled walker with dual-brake systems as claimed in claim 15, wherein the number of the wheels is four, and the four wheels are arranged in a rectangle.

18. The wheeled walker with dual-brake systems as claimed in claim 1 further comprising a seat back mounted on the frame and mounted above a side of the seat cushion.

19. The wheeled walker with dual-brake systems as claimed in claim 17 further comprising a seat back mounted on the frame and mounted above a side of the seat cushion.
